(19) United States
(12) Patent Application Publication
(10) Pub. No.: US 2011/0180563 A1
(43) Pub. Date: Jul. 28, 2011

(54) Dispensing Monitor

(76) Inventors: Jack Fitchett, Lakewood, CA (US); Alexander Mikhail, Irvine, CA (US)

(21) Appl. No.: 13/014,903

(22) Filed: Jan. 27, 2011

Related U.S. Application Data
(60) Provisional application No. 61/299,092, filed on Jan. 28, 2010.

(51) Int. Cl. B67D 7/16; B67D 7/08

(52) U.S. Cl. 222/1; 222/23; 222/40

(57) ABSTRACT

The disclosure herein includes a liquid pouring monitor cap that has an angle of orientation sensor. When the spout is attached to a liquor bottle, the orientation angle sensor determines the angle of the bottle with respect to the horizontal at all times while the dispensed substance is being poured from the bottle. This data regarding the duration of pouring at different pour angles may be stored for an entire pouring event in order to calculate the amount of liquid poured during the event.

### REFERENCE TO RELATED APPLICATIONS

This application claims priority benefit under 35 U.S.C. §119(e) of U.S. Provisional Application No. 61/299,092 filed Jan. 28, 2010, entitled “Dispensing Monitor.” The present application incorporates the disclosure of the foregoing application herein by reference in its entirety.

### FIELD

The present disclosure is related to the field of monitoring the dispensing of a substance.

### BACKGROUND

Dispensing monitoring systems, including liquid pouring monitoring systems, are useful for keeping track of the amount of substance dispensed out of a container for a variety of reasons. For example, a liquid medicine dispenser might have a liquid dispensing monitor to determine the amount of medication being dispensed to a patient. In another example, a flow rate monitor could be connected to a liquid container to inform an operator when the container is empty and requires replacing. In another application, an owner of an establishment that serves alcohol or alcoholic drinks may want to keep track of the amount of alcohol poured in each transaction.

In the case of a bar it is notoriously difficult for an owner to keep track of the amount of liquor poured and sold with various customers receiving free shots from bartenders and drinks being overpoured. Recently, liquor bottle caps have been developed that approximate the amount of liquor poured each time a liquor bottle is inverted. In order to calculate the amount of liquor poured, the systems detects when the bottle is inverted, calculates the time the bottle is inverted, and uses an approximate flow rate to calculate the amount of liquor poured.

These systems that detect tilt inversion use an assumed flow rate based on a pouring angle. However, bar tenders may pour drinks at different angles, and liquor pouring spouts will have significantly different pour rates when bottles are held at different angles. Therefore, unfortunately, these existing systems do not take into account the different pour angles at which a bartender may choose to pour the drink, resulting in higher or lower flow rates than the assumed flow rate. This ultimately causes inaccurate measurement of the total amount of alcohol poured for each pouring event. Therefore, a need exists for a more accurate liquid pouring monitoring device.

### SUMMARY

The present disclosure involves a device that accounts for the changing pour rate with the pour angle of a container dispensing a substance such as a liquid. For example, a sensing device that senses incremental changes in the orientation and pour angle can thereby calculate the flow rate of the liquor pouring out of the liquor bottle at different orientations, and can therefore compensate for the different flow rates associated with these different orientations. This will allow a liquor monitoring device or other substance dispensing device to accurately determine the total volume of liquor or other substance poured. The accuracy will be vastly superior to a system that only accounts for whether a bottle is pouring or not, and assumes a single flow rate regardless of the pour angle. This is because the assumption of a single flow rate when the container is in a pouring state inaccurately estimates the flow considering the variation in flow rates that can result from the many possible pouring angles of a container.

The present application discloses a device for measuring the dispensing of a substance comprising a container for holding a substance, a sensor attached to the container capable of measuring at least two different orientations with respect to gravity, and a monitoring station for receiving data from the sensor relating to the orientations of the container. The sensor disclosed may be, among other things, an accelerometer, a combination of tilt sensors, or a gyroscope.

A transmitter is disclosed that may be in electrical communication with a sensor that transmits data relating to the monitoring station. In some embodiments, the monitoring station includes a processor for calculating the volume of the substance dispensed from the container. The sensor may also include a timer. The substance dispensed may be liquor and the container may be a liquor bottle and the sensor may be integrated with a liquor pouring cap.

Also disclosed is a method for determining the amount of a substance dispensed comprising sensing at least two orientations of a container with respect to gravity during a pour event, and determining an amount of substance dispensed based on the orientations and duration of time the container remains at each angle for a dispensing event. After the orientation of the bottle is sensed, a flow rate may be calculated or determined based on the sensed orientation. This determination may be based on experimental data. The amount of time the container is held at each angle may be sensed or recorded. After the orientations and time are sensed the total volume of substance dispensed from the container may be calculated. These calculations can be done in any way known by those of ordinary skill in the art for calculating volume of liquids or substances poured out of a container based on data relating to angle of orientation of the bottle and timing of the different orientations.

A method for determining when a cap to a container has been removed or attached is also disclosed comprising providing a sensor on a cap that is able to sense the proximity of a container, sensing a proximity of the container to the sensor, and determining based on the proximity whether the cap is engaged or disengaged. The proximity may be a certain distance, or when the signal from the sensor reaches certain strength, the device may sense that the cap is engaged or disengaged. Also, the sensor may determine the amount of time the cap is disengaged, by keeping a time record of all the engage and disengage events. The proximity sensor may be an infrared proximity sensor, a magnetic sensing device or a mechanical sensing device or other proximity sensor known in the art. The sensor may transmit data based on a record of when the cap was engaged and disengaged to a monitoring station. This data may be compared to a record of data stored in a point of sale system to determine whether free liquor pours were served using the inventory software of the point of sale system.

### BRIEF DESCRIPTION OF THE DRAWINGS

FIG. 1 illustrates an overview of a liquid dispensing monitoring system in connection with the present disclosure.

FIG. 2 illustrates a perspective view of a cap in accordance with the present disclosure.

FIGS. 3A and 3B illustrate a circuit diagram of a sensor in an embodiment of the present disclosure.

FIG. 4 illustrates example waveform outputs from an accelerometer during disengage of a cap from a container in connection with the present disclosure.

FIG. 5 illustrates example waveform outputs from an accelerometer during engagement of a cap with a container in connection with the present disclosure.

FIG. 6 illustrates an embodiment of a circuit diagram of a sensor in an embodiment of the present disclosure

FIG. 7 illustrates an overview of a liquid dispensing monitoring system in connection with the present disclosure.

### DETAILED DESCRIPTION

The disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments. Furthermore, embodiments of the disclosure may include several novel features, no single one of which is solely responsible for its desirable attributes or which is essential to obtaining the adjectives herein described.

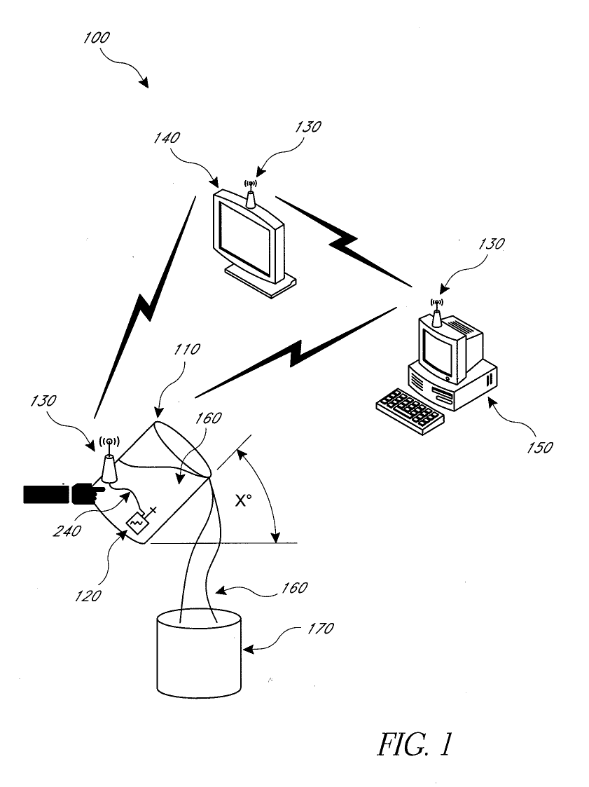

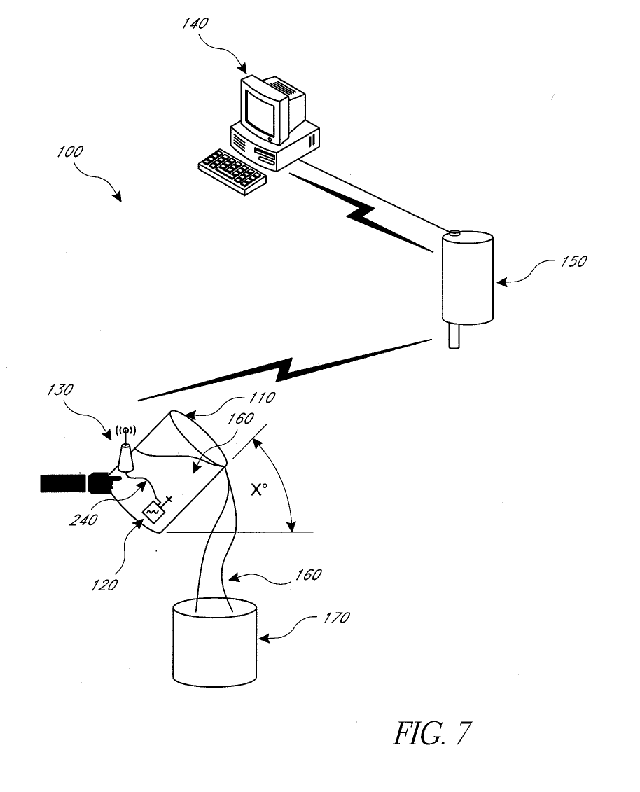

Systems, devices, and methods are disclosed herein for providing a substance dispensing monitor. More specifically, a device which monitors the amount of substance dispensed by measuring various factors that would affect the flow rate of a substance out of a container is disclosed. FIGS. 1-7 illustrate various exemplary embodiments and methods of the disclosure.

The disclosure herein includes a liquid pouring monitor cap that has an angle of orientation sensor. When the spout is attached to a liquor bottle, the orientation angle sensor determines the angle of the bottle with respect to the horizontal at all times while the dispensed substance is being poured from the bottle. This data regarding the duration of pouring at different pour angles may be stored for an entire pouring event in order to calculate the amount of liquid poured during the event.

Once all of the above data is recorded, an algorithm to determine how much liquid was poured during the event can be implemented that utilizes the information regarding pouring angles and pouring time elapsed at each angle. Based on the pour angle, previous testing of a particular spout can determine a flow rate of the spout at a particular pouring angle with a particular amount of volume of liquid contained in the bottle. During a pour event, the total time the bottle is held at each angle with respect to the horizontal for a pour event is recorded.

Utilizing the time a bottle with attached spout is held at each angle, and the approximation of the flow rate at each angle, the amount of alcohol poured while the bottle is held at each angle can be determined by integration of the flow rate over the duration of pouring. If the amount of alcohol at each angle is stored for an entire pour event the amounts recorded at each angle can be summed and the amount of liquid poured during each pour event may thereby be calculated.

Also, in an embodiment, further variables affecting the flow rate may be sensed and accounted for in a pouring monitoring algorithm. For example, when the bottle is being poured and a bartender moves the bottle down towards the glass and subsequently stops the movement of the bottle towards the glass, the sudden deceleration provides an increased flow rate. This occurs because the inertia of the liquid left in the bottle puts increased force towards the opening when the liquid decelerates in the foregoing situation.

Additionally, the flow rate is affected by the amount of liquid left in the bottle. Therefore, at one particular angle of inversion, the bottle will have different flow rates depending on the amount of liquid remaining. An algorithm could be applied in a method for determining the amount of liquid poured to compensate for these differences by determining when a bottle is newly opened, the amount of liquid in the bottle to start and keeping track of how much is dispensed until it is empty. All of these and other various factors may be accounted for in determining an accurate assessment of flow rate in a method for determining the amount of liquid dispensed.

In an embodiment, these liquor pouring spouts or other flow meters may be incorporated into various point of sale systems wirelessly or through other technology to match certain transactions to pour events. In one embodiment, the system may wirelessly transmit the information to a computer, which may optionally also have point of sale time data to determine all the information for each pour and match it to a particular transaction to provide the most information possible. Each monitor may also optionally have information about the type of alcohol and bottle size to which the monitor is attached. As apparent, the features and attributes of the specific embodiments disclosed herein may be combined in different ways to form additional embodiments, all of which fall within the scope of the present disclosure. In some embodiments, all of these features and embodiments may be implemented based on the systems, methods and devices described herein.

FIG. 1 illustrates an embodiment of a dispensing monitoring system 100. Illustrated is container 110 with sensor 120, transmitter 130, point of sale system 140, monitoring station 150 and receiving container 170. Container 110 holds a substance 160 to be dispensed which could be any type of material which may be dispensed from container 110 including liquids, solids particles, or other materials. Container 110 has sensor 120 which senses the various flow rate factors affecting the flow rate of substance 160 out of container 110. Transmitter 130 is electrically linked to sensor 120 by connection 240 and transmits data recorded or sensed by sensor 120 to a host monitoring station 150. Connection 240 may be an electronic hardwired connection, wireless connection or other connection capable of transmitting data. Host monitoring station 150 may be a computer capable of receiving data from transmitter 130 or a special purpose receiver. Host monitoring station 150 may or may not be integrated with and receive data from a point of sale system 140 such as an electronic cash register. The connection between the host monitoring station 150 and the point of sale system 140 may be a wired or wireless connection. Monitoring station 150 performs various algorithms on the data collected by sensor 120 and also optionally by the point of sale system 140 to output various information about any dispensing event sensed by sensor 120 including the total amount of substance 160 dispensed.

Sensor is a broad term and is to be given its ordinary and customary meaning to a person of ordinary skill in the art (i.e., it is not to be limited to a special or customized meaning) and includes, without limitation, accelerometers, combinations of tilt sensors, other angle sensing devices, temperature sensors, other acceleration sensors, and any other type of sensing device that detects attributes of container 110 and substance 160 inside that affect the rate of dispensing of substance 160 out of container 110. In one embodiment sensor 120 may be integrated with transmitter 130 or into any other component or accessory for container 110.

In one embodiment, sensor 120 is an accelerometer integrated into a pouring spout for a liquor bottle. In another embodiment, sensor 120 may be fixed to any other part of the bottle and is not limited to a pouring spout. For example, sensor 120 may be integrated into a device that is affixed to the bottom or side of container 110. In another embodiment, sensor 120 may be imbedded or attached to a sleeve that surrounds container 110.

Sensor 120 may also be a combination or variety of several tilt sensors that each sense when container 110 has been tilted a certain angle with respect to the horizontal. Such a combination of tilt sensors may be any suitable tilt sensor known in the art including a simple mercury tilt switch. In combination, the many tilt sensors will sense the dispensing time at a fixed number of tilt angles.

In addition, sensor 120 may include temperature sensors or other sensors that may affect the amount of substance 160 dispensed from container 110. For example any factors that affect the viscosity or other variables affecting flow rate of a liquid, for example, may be sensed by sensor 120.

In an embodiment, sensor 120 has an electronic memory, for example an EPROM memory, connected to sensor 120 for temporarily storing data or other information sensed by sensor 120. This data may be partially processed or conditioned before transmitting to monitoring station 150 or may be sent in raw form directly to monitoring station 150.

Transmitter is a broad term and may be any device capable of sending or receiving data to or from a monitoring or receiver station, computer or other device. In an embodiment, transmitter 130 may be an RF wireless transmitter, or other wireless transmitter that transmits data sensed by sensor 120 to monitoring station 150 for processing or optionally to the point of sale system 140. Also, transmitter 130 may be a wireless receiver capable of receiving data from transmitter 130 or other data transmitter. In one configuration, transmitter 130 may receive data from sensor 120 and transmit the data to monitoring station 150 or point of sale system 140. Furthermore, this data may further be relayed between monitoring station 150 or point of sale system 140 between transmitters 130 or wired connections or both. In another embodiment, transmitter 130 could be a wired connection between sensor 120 and monitoring station 150. Transmitter 130 may be connected to sensor 120 by any means known in the art including electrical wires, hardwired into a circuit board or wirelessly. In an embodiment, dispensing monitoring system 100 does not use transmitter 130, a monitoring station 150 or point of sale system 140 and instead processes and displays the information about the dispensing of substance 160 directly on a device attached or connected to container 110.

Point of sale system is a broad term and includes any device that records transactions and sales of a substance 160 that is dispensed out of a container 110. The point of sale system 140 may be an electronic cash register used to record the date time, and price of drinks purchased for each liquor transaction at a bar. This data is recorded and sent to monitoring station 150 so that point of sale data may be matched against dispensing events to determine which dispensing events correspond with which purchases at point of sale system 140. The point of sale system 140 may be a cash register at a pharmacy that records the amount of drug dispensed per transaction. Also, the point of sale system 140 could be an interactive system at a hospital or other patient care setting that allows patients to utilize a certain amount of pain meds or other medicine based on a daily allowance or some other limiting budget.

Monitoring station is a broad term and includes, without limitation, computers, microcontrollers, other microprocessor based devices, and any other device with the ability to process, transmit, store or receive data including, for example a network connected to transmitter 130 with a remote processing device either in a different room or far removed in a centralized location with access over the interne. The monitoring station 150 may be a computer that receives data from transmitter 130 and optionally from point of sale system 140 to determine various features of each dispensing event. The device connected to container 110 that contains the sensor 120 may also contain a processing device which predetermines the amount of substance 160 poured for each event before sending to the monitoring station 150. Also, monitoring station 150 may be integrated into point of sale system 140.

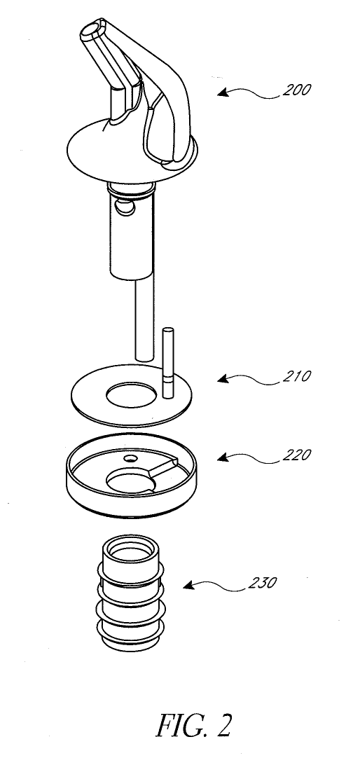

FIG. 2 illustrates a container cap 190, with a pour spout 200 that may incorporate sensor 120. Illustrated is pour spout 200, with circuit board 210, collar 220, and cork 230. Pour spout 200 provides a conduit for substance 160, for example, liquor, to flow from the container 110. Circuit board 210 may optionally include sensor 120, either being imbedded or connected, transmitter 130, and may optionally include either or both the point of sale system 140 and monitoring station 150. Also illustrated is collar 220 which provides a stop for spout 200 once engaged to container 110, and cork 230 which provides a seal between container 110 and pour spout 200 to prevent substance 160 from exiting container 110 through ways other than through pour spout 200.

Various algorithms may be used based on the various aspects of the dispensing event that may be recorded by sensor 120. One of these aspects may be illustrated angle X as shown in FIG. 1 of container 110 which is the angle of pouring of the container with respect to the horizontal. During a dispensing event the exact angle of the container with respect to the horizontal could be measured by an accelerometer or any angle sensing device. At each angle the amount of time container 110 is held at the specific angle could be recorded. The flow rate may then be determined from this data.

In a method to determine the flow rate based on an angle of pouring testing may be performed to match the flow rate of a particular substance from container 110 or container cap 190 while dispensing at a specific angle. For example, if the container 110 is a liquor bottle and the sensor 120 is connected to or embedded in a liquor pouring spout the liquor pouring spout's unique flow path geometry will dictate a unique flow profile and flow rate based on the viscosity of the liquid. Depending on how many factors are sensed, various factors may be averaged or assumed. For example, for a liquid, if viscosity, which may be determined by temperature, type of liquid, amount of substance 160 remaining in container 110 and other factors are not sensed then an average for these variables must be tested to determine an average viscosity in order to develop a method for determining the amount of liquid dispensed. Alternatively, an average for only some of the factors that make up viscosity and other relevant variables may be used.

In another embodiment, the type of substance 160 that is being poured is entered by the user or is assigned to a certain sensor 120. This is advantageous because, for example, various alcoholic drinks have different viscosities as they have different percentages of alcohol and different additives such as excess sugar which can increase or decrease viscosity. This will allow the information on the type of substance 160 to be included in the algorithm for determining flow rate by the monitoring station 150 in a method for determining the amount of substance 160 dispensed. In another embodiment, the amount of substance 160 in container 110 is accounted for by inputting the starting volume into monitoring station 150 of substance 160 in container 110 and when container 110 is first used. Next, monitoring station 150 may subtract the amount of volume of substance 160 dispensed from container 110 to determine the remaining volume of substance 160 in container 110. That way, the algorithm for determining flow rate at any point in time may utilize these additional variables for a more accurate determination of the flow rate and the amount of liquid remaining in container 110. Container cap 190 may also have a memory to store a unique ID that matches a certain type of substance 160 with a certain volume of container 110 so that when container cap 190 is engaged to a new container 110 the substance 160 volume information will be automatically transmitted to or already stored in monitoring station 150.

The angular velocity with which container 110 is rotated into pouring position could be detected by sensor 120 in order to further enhance the determination of the flow rate. An increased angular velocity of the container 110 will increase the amount of inertia of the substance 160 as it is directed towards the cap 190 thus increasing the flow rate.

In addition to determining the flow rate the amount of time container 110 is dispensing the substance 160 at each flow rate may also be determined. This allows monitoring station 150 or other computing device to compute the total amount of substance 160 dispensed by summing the total volume calculated by integrating each individual segment of constant flow rate over the time that the flow rate is constant. This can be represented by a flow rate versus time curve. To obtain the total volume of liquid one must integrate the area under the flow rate versus time curve. Variations of these and other algorithms known in the art may be implemented to calculate the amount of substance 160 dispensed.

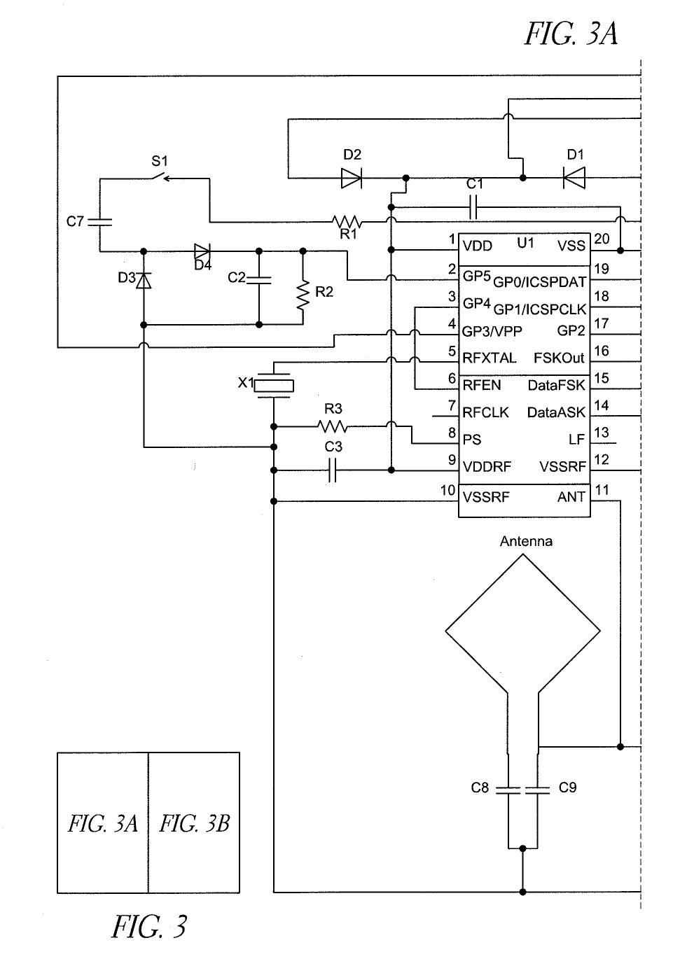

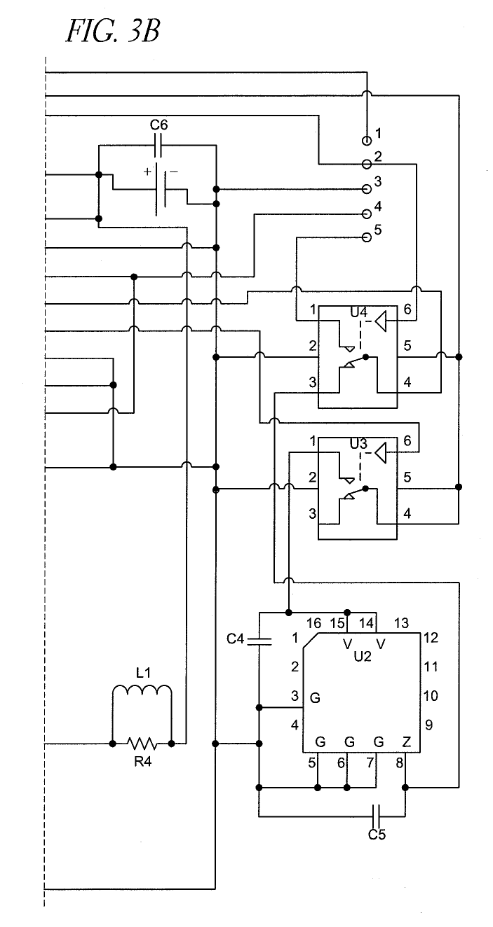

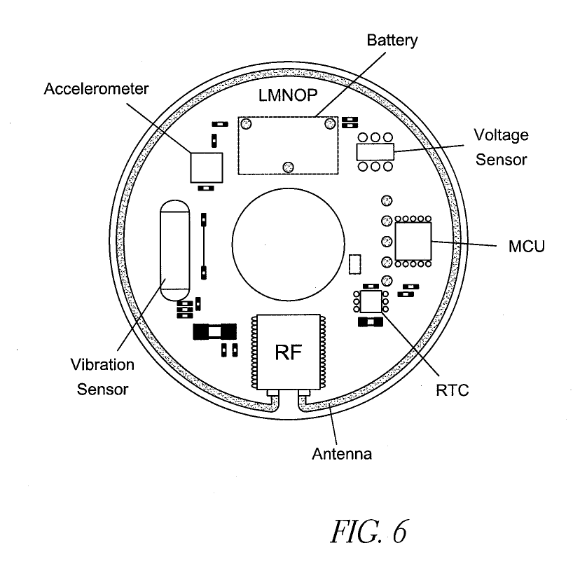

Various electronic systems may be used in a device that houses sensor 120 attached to container 110 that are known in the art. For example, as illustrated in FIG. 3 and FIG. 6, the system may include a micro controller or microprocessor connected to sensor 120. Once the data is sensed from sensor 120 the data could be stored on an EPROM or other digital memory until one or more dispensing events are completed. Once the dispensing event is completed the information may be transmitted to a host monitoring station 150 utilizing an RF ID antenna or other wireless transmitting device. In another embodiment, information may be continuously transmitted to host monitoring station 150 or at any other interval.

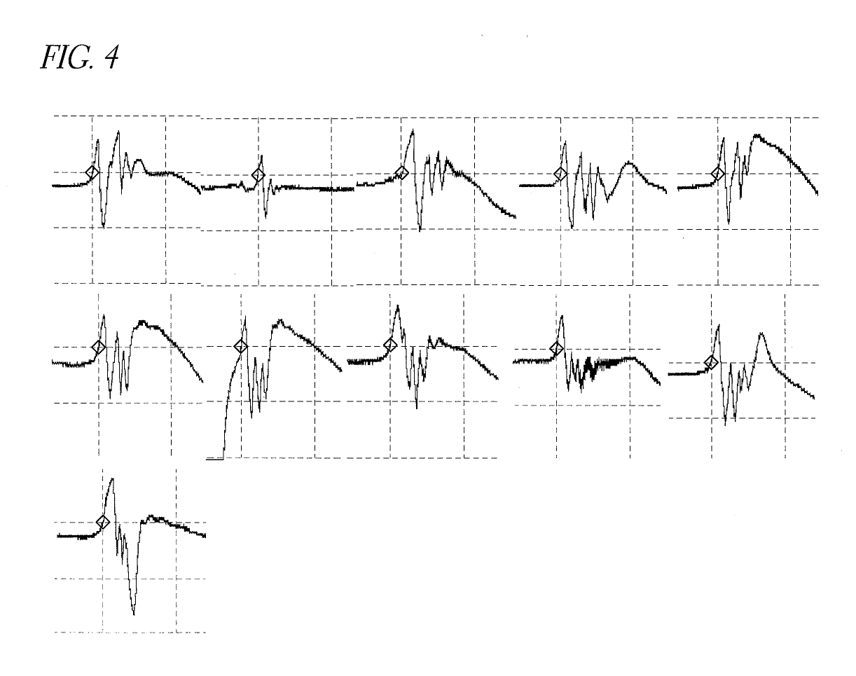

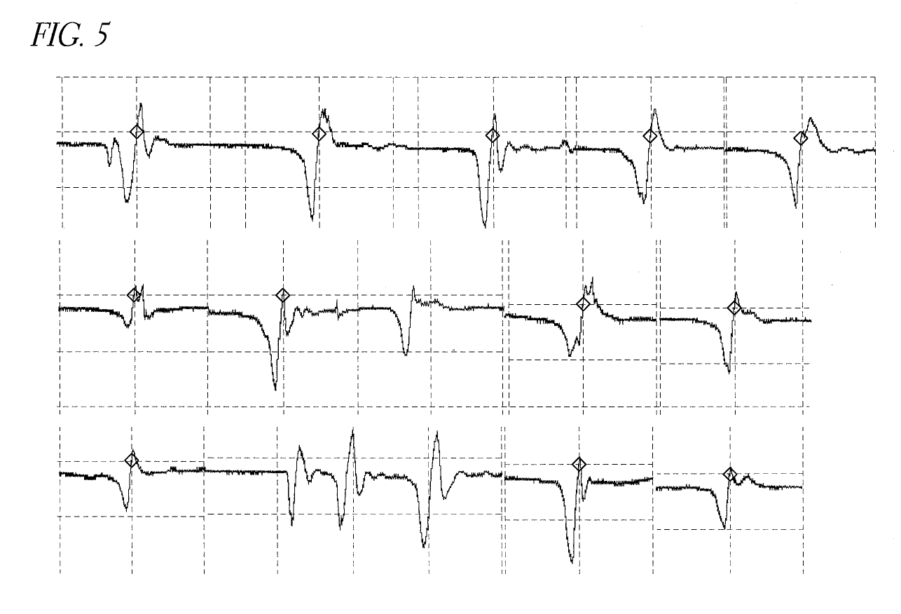

In addition to calculating the amount of substance 160 dispensed, the sensor may sense other attributes and events that occur in relation to the container 110. For example, sensor 120 may sense the removal of container cap 190 from container 110 and the addition or engagement of container cap 190 to container 110. This may be accomplished by an algorithm that analyzes the waveform of acceleration or other movement detected by sensor 120 that results from removing container cap 190 from container 110. Once container cap 190 is removed, sensor 120 may keep track of the waveform to determine whether or not it represents a removal container cap 190, or a simple pick up and jiggle of container 110. This is useful as it will prevent bartenders from removing, for example, a liquor pouring spout from a container 110, pouring a recorded volume of alcohol or other substance 160 and reattaching the container cap 190 to container 110 without registering pours. Example waveform outputs from an accelerometer during container cap 190 disengage is illustrated in FIG. 4, and example engage waveform outputs are illustrated in FIG. 5.

Container cap 190 may also sense removal or replacement of the cap from or to container 110 utilizing a proximity sensor incorporated into sensor 120 and a corresponding proximity sensor or indicator on the container 110. The proximity sensor associated with sensor 120 or separate from sensor 120 can sense the proximity of container cap 190 to the neck or other areas of the dispensing container 110 by mechanical, infrared, magnetic or other techniques known in the art. This will allow the proximity sensor to determine when the cap 190 has been engaged or disengaged from container 110.

In an embodiment, container cap 190 may also have a power saving feature that allows the sensor 120 and associated electronics to consume little power in sleep mode while not in use. In an embodiment, sensor 120 will not be activated until the sensor registers some power up event. For example, sensor 120 may sense the vibration from container 110 being pulled off of a shelf or out of a tray before it is dispensed. This event may be detected by sensor 120 or other motion detector. At this point the sensor 120 and other functionality of the device associated with sensor 120 may be powered on to begin recording angles, temperature, acceleration, time and other relevant data to be transmitted to monitoring station 150.

In another embodiment, an algorithm may match the point of sale transactions with dispensing events recorded by monitoring station 150. To do this, information is entered for each point of sale transaction at the point of sale system 140. This information may include, for example, in the liquor monitoring arena, the type of drink, the customer, the bartender, the time, and any other relevant information. Through use of an algorithm this information could be matched to specific dispensing events to determine the actual types and amounts of alcohol poured into the drink. This will provide the owner of a bar with additional information including substitutions for different types of alcohol, wrong ingredients, over pours, under pours, giveaways, and various other types of information relevant to dispensing of substance 160.

What is claimed is:

1. A device for measuring the dispensing of a substance comprising:
a container for holding a substance;
a sensor attached to the container capable of measuring at least two different orientations of the container with respect to gravity; and
a monitoring station for receiving data from the sensor relating to the at least two orientations of the container.

2. The device of claim 1 wherein the sensor includes an accelerometer.

3. The device of claim 1 wherein the sensor includes at least two tilt sensors.

4. The device of claim 1 wherein the sensor includes a gyroscope.

5. The device of claim 1 including a transmitter in electrical communication with the sensor that transmits the data from the sensor relating to the at least two orientations of the container to the monitoring station.

6. The device of claim 1 wherein the monitoring station includes a processor for calculating the volume of the substance dispensed from the container.

7. The device of claim 1 wherein the sensor includes a timer.

8. The device of claim 1 wherein the substance is liquor and the container is a liquor bottle, and the sensor is integrated with a liquor pouring cap that removably connects to the liquor bottle.

9. A method for determining the amount of a substance dispensed comprising:
sensing at least two orientations of a container with respect to gravity during a pour event; and
determining an amount of substance dispensed based on the at least two orientations and a duration of time the container remains at the at least two orientations.

10. The method of claim 9 wherein the total volume of the substance dispensed from the container is calculated.

11. The method of claim 9 wherein a flow rate of the substance out of the container is determined for each of the at least two orientations.

12. The method of claim 11 wherein the flow rate is determined based on experimental data with the container.

13. The method of claim 11 wherein the time the container is held at each of the at least two orientations is recorded.

14. A method for determining when a cap to a container has been removed or attached comprising:
providing a sensor on a cap that is able to sense the proximity of a container;
sensing a proximity of the container to the sensor; and
determining based on the proximity whether the cap is engaged or disengaged.

15. The method of claim 14 wherein the sensor is an infrared proximity sensor.

16. The method of claim 14 wherein the sensor is a magnetic sensing device.

17. The method of claim 14 wherein the sensor is a mechanical sensing device.

18. The method of claim 14 wherein the sensor transmits data based on a record of when the cap was engaged and disengaged to a monitoring station.

19. The method of claim 18 wherein the data is compared to a record of data stored in a point of sale system to determine whether free liquor pours were served.

20. The method of claim 14 wherein the cap is a liquor pouring cap, and the container is a liquor bottle.
